(19) United States
(12) Patent Application Publication
(10) Pub. No.: US 2021/0147114 A1
(43) Pub. Date: May 20, 2021

(54) STORAGE CONTAINER AND A METHOD FOR ITS MANUFACTURE

(71) Applicant: PLASEL PLASTIC LTD., Lavon Industrial Park (IL)

(72) Inventor: Alon Nyul, Kfar Vradim (IL)

(21) Appl. No.: 17/047,477

(22) PCT Filed: Mar. 21, 2019
(86) PCT No.: PCT/IL2019/050317

§ 371 Date: Oct. 14, 2020

(30) Foreign Application Priority Data
Apr. 23, 2018 (IL) 258884

(51) Int. Cl. B65D 21/08; B65D 85/20

(52) U.S. Cl. CPC B65D 21/086; B65D 2543/00203; B65D 2543/00101; B65D 85/20

(57) ABSTRACT

A storage container configured for coaxially aligning and retaining an elongate article received therein and a method for manufacturing and assembling same.

### TECHNOLOGICAL FIELD

The present disclosure is directed to a storage container and a method for manufacturing and assembling same. More specifically, the present disclosure is directed to at least a cap member or a base member of a so called self-aligning container, configured for coaxially aligning and retaining an elongate article received therein.

### BACKGROUND ART

References considered to be relevant as background to the presently disclosed subject matter are listed below:
U.S. Pat. No. 7,537,116
U.S. Pat. No. 7,740,136
TopPack Conical, a Rose Plastic publication: August 2016 [retrieved on Apr. 15, 2018]. Retrieved from:<http://www.rose-plastic.com/catimport/pdf/TopPackConical_DB_EX.pdf>
Center Pack, a Plasel Plastic Ltd. Publication [retrieved on Apr. 15, 2018]. Retrieved from: <http://www.plaselplastic.com/center-pack>

Acknowledgement of the above references herein is not to be inferred as meaning that these are in any way relevant to the patentability of the presently disclosed subject matter.

### BACKGROUND

U.S. Pat. No. 7,537,116 discloses a zero-clearance packaging for elongate objects, in particular, elongate objects subject to fracture, comprises a packaging sleeve with internal and external parts with a closure disposed therebetween which makes it possible to push the parts together in telescope fashion and to hold the same in particular closed position, wherein at least one elastic tension structure is disposed in at least one of the parts, which stricture prestresses the parts in a closure direction of the packaging against the object stored in the packaging.

The elastic tension structure comprises bellows formed by an axial pail of the wall of the parts.

U.S. Pat. No. 7,740,136 discloses a packaging container with a clamping base and an attachable protective cap serves for a unilateral, clamping or holding of a tool, an instrument, or another longitudinal object, where the clamping base comprises a clamping holder with a plurality of springy clamping jaws fastened on one side which define a nearly centric, central clamping reception, in which clamping reception the tool is inserted and held clampingly. In order to achieve that the insertion force to be applied is low when the packaging container is equipped, however, a high clamping force is given with the protective cap attached. The protective cap abuts against the outside circumference of the clamping jaws when it is attached to the clamping base and prestresses said clamping jaws in direction of the clamping reception.

### GENERAL DESCRIPTION

According to a first aspect of the present disclosure there is provided a tubular container element comprising a tubular body configured with an open end and an closed end, the closed end is configured with a cap member attached thereto, said cap member comprising a tool retention portion extending into a portion of the tubular body and tapering towards a flat top base, said top base snugly bearing at the closed end of the tubular body.

According to a second aspect of the present disclosure there is provided a container comprising a base member and a cover member configured for telescopically closing over one another, said cover member being a tubular container element comprising a tubular body configured with an open end and an closed end, the closed end is configured with a cap member attached thereto, said cap member comprising a tool retention portion extending into a portion of the tubular body and tapering towards a flat top base, said top base snugly bearing at the closed end of the tubular body.

According to a third aspect of the disclosure there is a method for manufacturing a container cover element, the method comprising the following steps:
integrally molding a single element comprising a tubular body configured with an open bottom end and a top end, said top end comprising a cap arresting location, and a cap member coaxially coextending at the top end and attached thereto through two or more gates, said cap member comprising a tool retention portion extending from said two or more gates and tapering towards a flat top base, and an arresting portion configured for arresting with said cap arresting location;
axially displacing the cap member into the tubular body thereby detaching the two or more gates, until the cap arresting location arrests the arresting portion and the top base bears at the top end of the tubular body.

The container cover element is configurable between a preassembled position at which the cap member integrally coextends and projects from the top end of the tubular container element, and an assembled position, at which the two or more gates are ripped and the cap member is coaxially displaced inwards towards the tubular container element, and wherein the top base bears at a top edge of the tubular container element.

The term gate as used herein in the specification and claims denotes the channel through which the molten resin flows from one molded portion into another molded portion.

During the molding process the container cover element can further be configured, at a bottom portion thereof, with a cover locking arrangement for engagement with a corresponding base locking arrangement of a container base member.

Any one or more of the following features, designs and configurations can be incorporated in any aspect associated with the container member according to the present disclosure, either separately or in various combinations thereof:
At the assembled position a bottom face of the top base can snugly bear over a top edge of the tubular body;
At the assembled position a top face of the top base can extend flush with a top edge of the tubular body;
The cap member can be configured for only axial displacement into the tubular body, wherein at least an axial projection of the tool retention portion has a shape corresponding with the inside cross section shape of the tubular body;
The cap member can be configured with axial ribs, laterally extending between a bottom face of the top base and outside surface of the tool retention portion.
The axial ribs can reinforce the cap member and axially stabilize it within the tubular body;
The axial ribs can be symmetrically disposed over the top cap, under the top base;
The two or more gates can be symmetrically disposed bout a longitudinal axis of the tubular body;
The two or more gates are breakable upon axial displacement of the cap member with respect to the tubular body;
At the preassembled position a bottom edge of the tool retention portion extends from a top edge of tubular body;
At least an inside surface of the tool retention portion can be conically shaped, with an open bottom base;
The tool retention portion can be solid, with a smooth, uninterrupted enveloping surface;
The base member can be configured as an internal member, axially displaceable within the cover member;
The cap member can be attached to the tubular member by a snap-type attachment;
The cap arresting location of the tubular member can be a projection from inside wall faces of the tubular member and the arresting portion can be a depressed or recessed location at the cap member, configured for arresting the cap arresting location;
One or both of the cap arresting location and the arresting portion can extend continuously around the respective tubular member and the cap member;
The tubular element can be polygonal or cylindrical;
The container base and the container cover can be configured for coaxial telescopic displacement so as to adjust the storage space length of the container, so as to suit variable tool length;
The tool retention portion can be configured for self-centering (central positioning) of a tool received within a container, regardless of tool diameter, shape and length;
The tool retention portion can be configured for zero clearance bearing over a tool received in the container;
The base member and the cover member can be configured with a locking arrangement facilitating relocking thereof at a variable height;
The base member can be configured with a grip portion at bottom portion thereof, said grip portion configured for extending outside of a telescopically accommodating cover member;
At least the cover member can be configured of transparent or translucent material;
Side walls of the cover member can extend upwards and parallel to a longitudinal axis of the cover member, or they can extend at an angle thereto.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A and 1B are perspective views of a prior art self-aligning tool container, before and after assembly, respectively, made translucent for visualization;

FIG. 2 is a perspective view of a self-aligning tool container, with a cover member, according to the present disclosure, the cover member made translucent for visualization;

FIG. 3 is a top perspective view of a cover member, according to the present disclosure;

FIG. 4A is a longitudinal section along line IV-IV in FIG. 3;

FIG. 4B is an enlargement of the portion marked B in FIG. 4A;

FIG. 4C is an isometric view of FIG. 4B, rotated clockwise;

FIG. 4D is an isolated translucent view of only a cap member of the cover member according to the present disclosure;

FIGS. 5A to 5E are sequential steps of assembling the cover member according to the disclosure; and

FIGS. 6A and 6B are an example of a tubular cover member with a cap member according to another example of the disclosure, having a triangular cross section.

### DETAILED DESCRIPTION OF EMBODIMENTS

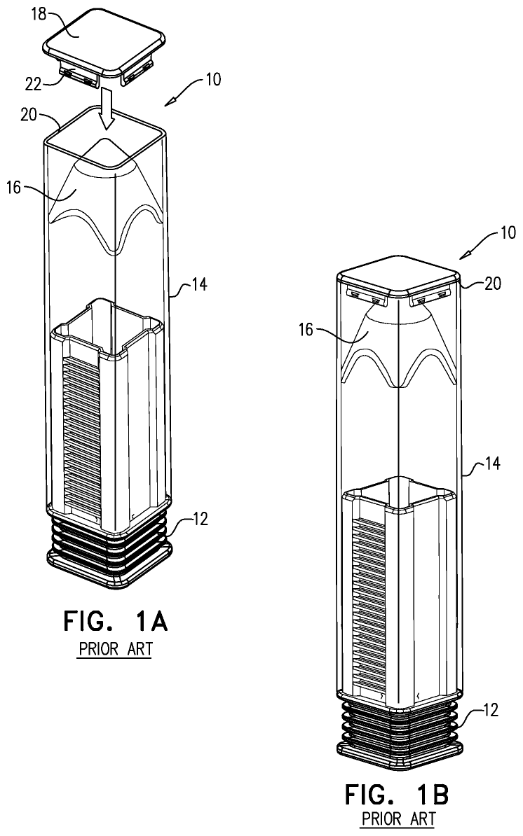

Attention is first directed to FIGS. 1A and 1B directed to a self-aligning container according to some prior art, generally designated 10, comprising a base member 12 and a cover member 14, both of square cross section. It is noted that the cover member 14 is integrally configured at a top end thereof with a tool retention portion 16 being a conical seat tapering towards a top end of the cover member 14. In order to obtain a closed top of the cover, a cover element 18 is molded separately of the cover member 14, and is then snappingly attached at a top edge 20 of the cover member through snap wings 22.

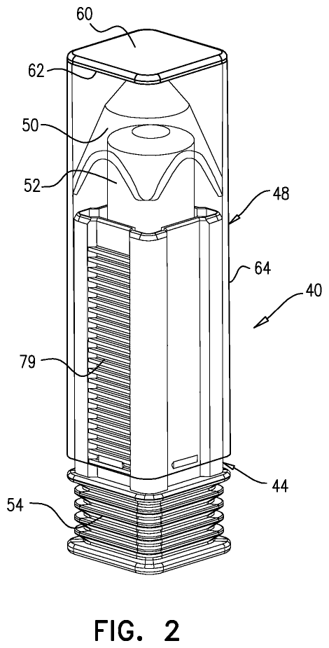

Turning now to FIG. 2 of the drawings, there is disclosed a self-aligning container according to the present disclosure, generally designated 40, comprising a base member 44 telescopically received within cover member 48, wherein it is noted that the cover member 48 is configured at a top end thereof with a tool retention portion 50 and a tool 52 is received within the container 40, centrally retained therewithin at substantially zero tolerance as it is being self-centered and axially trapped (captured) between a supporting element 54 at a bottom of the base member 44 and the conical tool retention portion 50. A top cover 60 is disposed over a top edge 62 of the cover member 48, as will be discussed hereinafter in detail, however, wherein said top cover 60 is integral with the tool retention portion 50, both being separate from a tubular body 64 of the cover member.

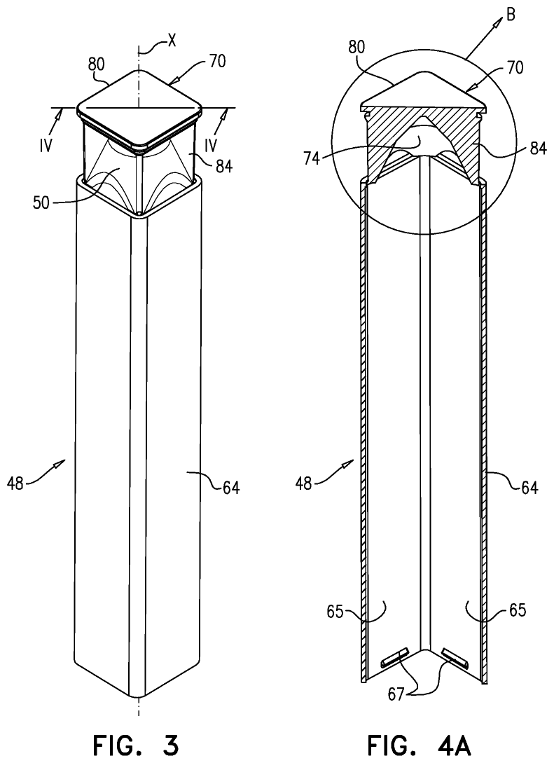

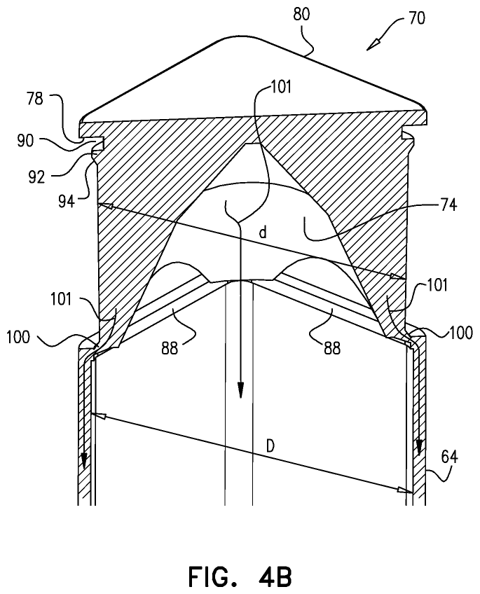

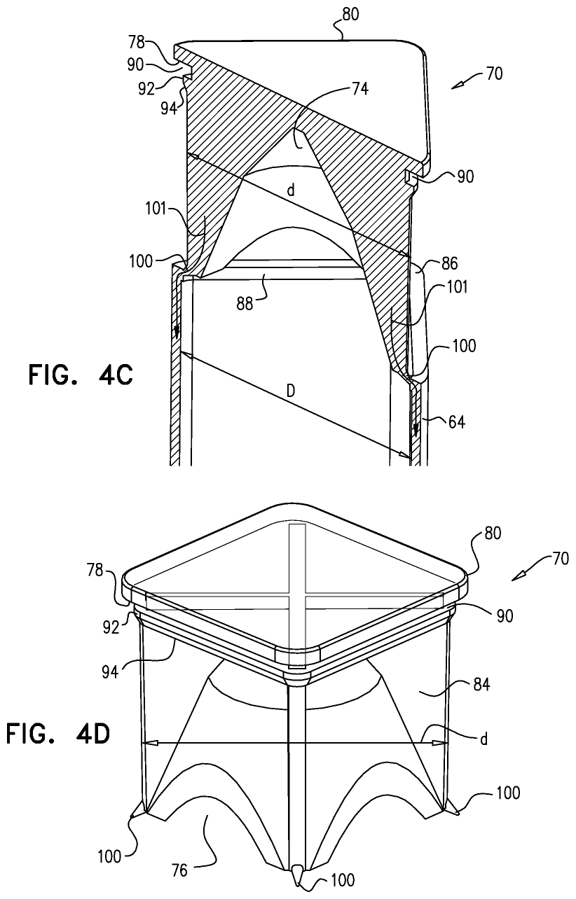

With further reference also to FIGS. 3 to 5, at the molding process of manufacturing the cover member 48, the tubular body 64 is molded, in the particular example as a polygonal tubular element (rectangular to be more specific), extending along a longitudinal axis X. As an integral process of the molding, a cap member 70 is integrally molded therewith (seen isolated in FIG. 4D), said cap member 70 comprising a tool retention portion 50 in the form of a cone-like shape having a downward facing space 74 with a wide bottom opening 76, tapering towards a bottom face 78 of a flat top base 80. The cone shaped tool retention portion 50 is reinforced by four ribs 84 laterally projecting and having a normal substantially parallel to the longitudinal axis X. The width of the cap member measured along the diagonal d is slightly less than the diagonal D within the tubular body 64 (d<D).

Further noted, the top portion (top edge 86) of the tubular body 64 is configured with cap arresting location, namely with an inwardly projecting annular rib 88, and the cap member 70 is configured, below the top base 80 with an annular recces 90, extending between the bottom face 78 and an annular rim 92 having a chamfered bottom face 94. The annular recces 90 is sized for snugly receiving the annular rib 88 of the tubular body 64.

Inside faces 65 of the tubular body 64 are configured, at a bottom portion thereof, with a locking lug 67, configured for locking engagement with one of a plurality of corresponding arresting teeth 79 (FIG. 2) disposed over an external surface of the base member 44, thereby facilitating arresting the cover member 48 at any variable height.

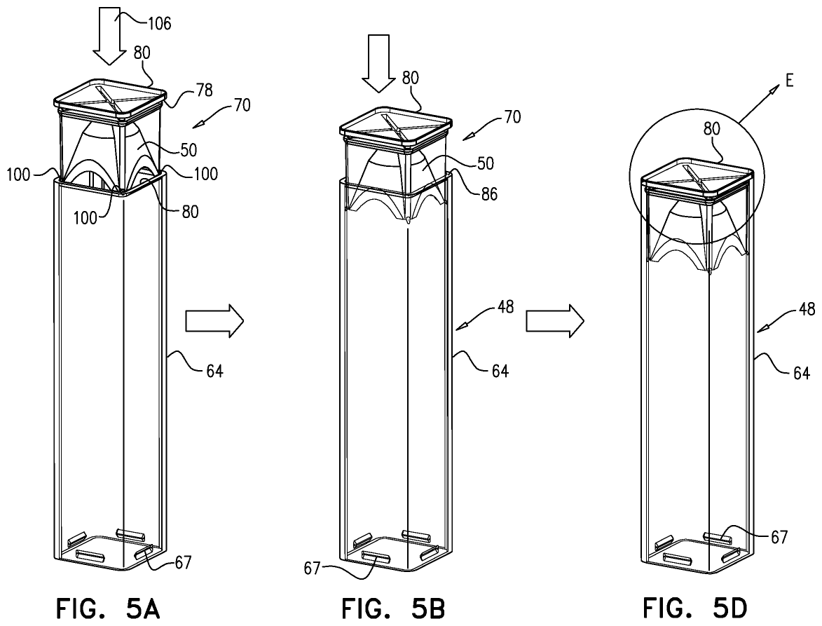

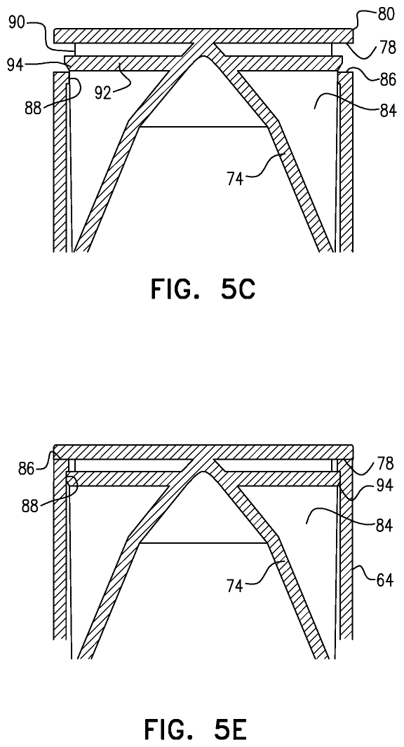

It is seen that the cap member 70 is integrally molded with the tubular body 64, wherein, molten resin flows in direction from the cap member 70 towards the tubular body 64 through two or more (four in the present example), symmetrically extending gates 100 (flow path represented by arrowed lines 101 in FIGS. 4B and 4C). It is however appreciated that the resin flow direction is part of the molding design process, and the flow direction results from engineering considerations. The gates 100 are fine and are configured such that upon axial displacement of the cap member 70 against the tubular body 64 (in direction of arrows 106 seen in FIG. 5) the gates 100 are ripped, whereby the cap member 70 becomes detached from the tubular body 64 (FIGS. 5B and 5C). However, the flat top 80 remains as an integral unit with the tool retention portion 50 having a conical space 74, and whereby further displacement of the cap member 70 in direction of arrow 106 entails snap engagement of the annular rib 88 (of tubular body 64) within the annular recces 90 (of cap member 70), with chamfered slope 94 facilitating such displacement and engagement. As clearly seen in FIG. 5E, at the final assembly position, the bottom face 78 of the cap member 70 snugly bears over the top edge 86 of the tubular body 64.

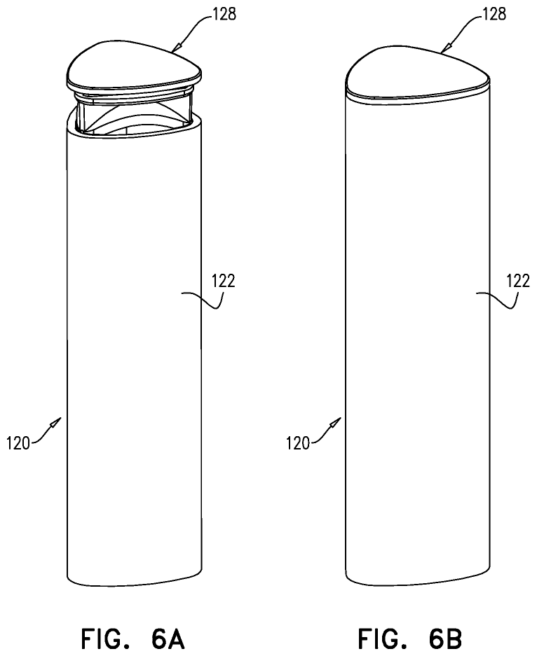

FIGS. 6A and 6B illustrate yet an example of a tubular cover member generally designated 120, being of substantially similar configuration as the example of FIGS. 2 to 5, however wherein the tubular body 122 has a triangular tubular shape with rounded longitudinal edges and wherein the cap member 128 has a similar cross section, with all functional aspects being similar to the previous example.

1-28. (canceled)

29. A container cover element, comprising:
a tubular body configured with an open end and a closed end, the closed end is configured with a cap member attached thereto;
said cap member comprising a tool retention portion extending into a portion of the tubular body and tapering towards a flat top base, said top base snugly bearing at the closed end of the tubular body.

30. The container cover element according to claim 29, wherein the cap member coaxially coextends at the top end of the container cover and is attached thereto through two or more gates, the tool retention portion extending from said two or more gates and tapering towards a flat top base, and an arresting portion configured for arresting with said cap arresting location.

31. The container cover element according to claim 30, being configurable between a preassembled position at which the cap member integrally coextends and projects from the top end of the container cover, and an assembled position, at which the two or more gates are ripped and the cap member is coaxially displaced inwards towards the container cover, and wherein the top base bears at a top edge of the container cover.

32. The container cover element according to claim 31, wherein at the assembled position, a bottom face of the top base snugly bears over a top edge of the tubular body.

33. The container cover element according to claim 29, wherein the cap member is configured for only axial displacement into the tubular body, wherein at least an axial projection of the tool retention portion has a shape corresponding with the inside cross section shape of the tubular body.

34. The container cover element according to claim 29, wherein the cap member is configured with axial ribs, laterally extending between a bottom face of the top base and outside surface of the tool retention portion.

35. The container cover element according to claim 34, wherein the axial ribs reinforce the cap member and axially stabilize it within the tubular body.

36. The container cover element according to claim 30, wherein the two or more gates are breakable upon axial displacement of the cap member with respect to the tubular body.

37. The container cover element according to claim 31, wherein at the preassembled position, a bottom edge of the tool retention portion extends from a top edge of tubular body.

38. The container cover element according to claim 29, wherein the tool retention portion includes at least an inside surface that is conically shaped, with an open bottom base.

39. The container cover element according to claim 29, wherein the tool retention portion is solid, with a smooth, uninterrupted enveloping surface.

40. The container cover element according to claim 30, wherein at least one of the cap arresting location or the arresting portion extends continuously around the respective tubular member and the cap member.

41. The container cover element according to claim 29, configured for coaxial telescopic displacement about a container base so as to adjust the storage space length of the container, so as to suit variable tool length.

42. The container cover element according to claim 30, wherein the tool retention portion is configured for self-centering of a tool received within a container.

43. The container cover element according to claim 29, wherein the tool retention portion is configured for zero clearance bearing over a tool received in the container.

44. The container cover element according to claim 29, wherein the cap member and the tubular body are configured with a locking arrangement facilitating relocking thereof at a variable height.

45. The container cover element according to claim 29, wherein at least the tubular body is configured of transparent or translucent material.

46. A container, comprising:
a base member and a cover member configured for telescopically closing over one another;
said cover member comprising a tubular container element which includes a tubular body configured with an open end and an closed end, the closed end is configured with a cap member attached thereto;
said cap member comprising a tool retention portion extending into a portion of the tubular body and tapering towards a flat top base, said top base snugly bearing at the closed end of the tubular body.

47. The container according to claim 46, wherein the cap member coaxially coextends at the top end of the container cover and is attached thereto through two or more gates, the tool retention portion extending from said two or more gates and tapering towards a flat top base, and an arresting portion configured for arresting with said cap arresting location.

48. A method for manufacturing a container cover element, the method comprising:
integrally molding a single element comprising a tubular body configured with an open bottom end and a top end, said top end comprising a cap arresting location, and a cap member coaxially coextending at the top end and attached thereto through two or more gates; said cap member comprising a tool retention portion extending from said two or more gates and tapering towards a flat top base, and an arresting portion configured for arresting with said cap arresting location; and
axially displacing the cap member into the tubular body, thereby detaching the two or more gates, until the cap arresting location arrests the arresting portion and the top base bears at the top end of the tubular body.
